(19) United States
(12) Patent Application Publication
(10) Pub. No.: US 2008/0154600 A1
(43) Pub. Date: Jun. 26, 2008

(54) System, Method, Apparatus and Computer Program Product for Providing Dynamic Vocabulary Prediction for Speech Recognition

(75) Inventors: Jilei Tian, Tamere (FI); Jussi Leppanen, Tampere (FI); Imre Kiss, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/614,159

(22) Filed: Dec. 21, 2006

(51) Int. Cl. G10L 15/00

(52) U.S. Cl. 704/251; 704/270.1; 704/E15.04

(57) ABSTRACT

An apparatus for providing dynamic vocabulary prediction for setting up a speech recognition network of resource constrained portable devices may include a recognition network element. The recognition network element may be configured to determine a confidence measure for each candidate recognized word for a current word to be recognized. The recognition network element may also be configured to select a subset of candidate recognized words as selected candidate words based on the confidence measure of each one of the candidate recognized words, and determine a recognition network for a next word to be recognized, the recognition network including likely follower words for each of the selected candidate words, e.g. using language model and highly frequently used words.

### TECHNOLOGICAL FIELD

Embodiments of the present invention relate generally to speech processing technology and, more particularly, relate to a method, apparatus, and computer program product for providing dynamic vocabulary prediction for setting up speech recognition network of resource constraint portable devices.

### BACKGROUND

The modem communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, etc. The services may also be in the form of interactive applications in which the user may respond to a network device in order to perform a task, play a game or achieve a goal. The services may be provided from a network server or other network device, or even from the mobile terminal such as, for example, a mobile telephone, a mobile television, a mobile computer, a mobile gaming system, etc.

In many applications, it is necessary for the user to receive audio information such as oral feedback or instructions from the network or mobile terminal or for the user to give oral instructions or feedback to the network or mobile terminal. Such applications may provide for a user interface that does not rely on substantial manual user activity. In other words, the user may interact with the application in a hands-free or semi-hands free environment. An example of such an application may be paying a bill, ordering a program, requesting and receiving driving instructions, etc. Other applications may convert oral speech into text or perform some other function based on recognized speech, such as dictating a short message service (SMS) or email, etc. In order to support these and other applications, speech recognition applications (applications that produce text from speech), speech synthesis applications (applications that produce speech from text), and other speech processing devices are becoming more common.

Speech recognition, which may be referred to as automatic speech recognition (ASR), may be conducted by numerous different types of applications. A dictation engine, which may be employed for isolated word speech recognition, is one example of such an application which may include a large vocabulary of words that may be recognized. For example, the dictation engine may include a vocabulary set of 100,000 words or more. Each word of the vocabulary may have a corresponding acoustic model by concatenating subword acoustic models, such as phonemic HMMs. Speech recognition, such as may be performed by a Viterbi decoder, often involves comparing speech to various ones of the acoustic models in order to find a model most likely to have produced the speech. During a speech recognition process, it may be desirable for speech recognition to be performed on a subset of the entire vocabulary in order to reduce the number of models that must be compared to a given speech sample, so that it can be used in a resource constrained embedded system with low memory and computational complexity. However, a typical recognition vocabulary for a next word to be recognized is often formed as a subset of the entire vocabulary based on a fixed number of candidate words and information from the language model. This conventional mechanism can result in a large requirement for runtime memory resource usage.

However, with the ubiquitous nature of mobile terminals which may be resource constrained, it is becoming increasingly desirable to improve the performance of mobile terminals without increasing requirements for memory size and processing power. Accordingly, it may be desirable to provide speech recognition capabilities that avoid the disadvantages described above.

### BRIEF SUMMARY

A method, apparatus and computer program product are therefore provided for providing dynamic vocabulary prediction for speech recognition. As such, for example, an efficient dynamic vocabulary prediction for large vocabulary isolated speech recognition in resource-constrained systems may be provided. According to exemplary embodiments of the present invention, a recognition network may be dynamically created as a subset of a vocabulary of words. In this regard, rather than selecting a fixed number of candidate words which may be compared to a speech sample for recognition, embodiments of the present invention dynamically generate a recognition network for each word to be recognized. Furthermore, embodiments of the present invention account for the fact that even previously recognized words may not have been recognized properly in defining the recognition network for each word to be recognized. Thus, flexible and efficient speech recognition may be provided.

In one exemplary embodiment, a method of providing dynamic vocabulary prediction for speech recognition is provided. The method includes determining a confidence measure for each candidate recognized word for a current word to be recognized, selecting a subset of candidate recognized words as selected candidate words based on the confidence measure of each one of the candidate recognized words, and determining a recognition network for a next word to be recognized. The recognition network may include likely follower words for each of the selected candidate words using language model and supplementary words.

In another exemplary embodiment, a computer program product for providing dynamic vocabulary prediction for speech recognition is provided. The computer program product includes at least one computer-readable storage medium having computer-readable program code portions stored therein. The computer-readable program code portions include first, second and third executable portions. The first executable portion is for determining a confidence measure for each candidate recognized word for a current word to be recognized. The second executable portion is for selecting a subset of candidate recognized words as selected candidate words based on the confidence measure of each one of the candidate recognized words. The third executable portion is for determining a recognition network for a next word to be recognized. The recognition network may include likely follower words for each of the selected candidate words using language model and supplementary words.

In another exemplary embodiment, an apparatus for providing dynamic vocabulary prediction for speech recognition is provided. The apparatus includes a recognition network element. The recognition network element may be configured to determine a confidence measure for each candidate recognized word for a current word to be recognized. The recognition network element may also be configured to select a subset of candidate recognized words as selected candidate words based on the confidence measure of each one of the candidate recognized words, and determine a recognition network for a next word to be recognized. The recognition network may include likely follower words for each of the selected candidate words using language model and supplementary words.

In another exemplary embodiment, an apparatus for providing dynamic vocabulary prediction for speech recognition is provided. The apparatus includes means for determining a confidence measure for each candidate recognized word for a current word to be recognized, means for selecting a subset of candidate recognized words as selected candidate words based on the confidence measure of each one of the candidate recognized words and means for determining a recognition network for a next word to be recognized. The recognition network may include likely follower words for each of the selected candidate words using language model and supplementary words.

In another exemplary embodiment, a system for providing dynamic vocabulary prediction for speech recognition is provided. The system may include a speech processing element, a speech recognition engine and a recognition network element. The speech processing element may be configured to segment input speech into a series of words including a current word to be recognized and a next word to be recognized as well as feature extraction. The speech recognition engine may be configured to determine candidate recognized words corresponding to each word of the series of words based on a recognition network dynamically generated for each word of the series of words. The recognition network element may be configured to determine a confidence measure for each candidate recognized word for the current word to be recognized, to select a subset of candidate recognized words for the current word to be recognized as selected candidate words based on the confidence measure of each one of the candidate recognized words for the current word to be recognized, and to determine a next recognition network for a next word to be recognized. The next recognition network may include likely follower words for each of the selected candidate words using language model and supplementary words.

Embodiments of the invention may provide a method, apparatus and computer program product for employment in systems to enhance speech processing. As a result, for example, mobile terminals and other electronic devices may benefit from an ability to perform speech processing in an efficient manner without suffering performance degradation. Accordingly, accurate word recognition may be performed using relatively small amounts of resources.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of a system for providing dynamic vocabulary prediction for speech recognition according to an exemplary embodiment of the present invention;

FIG. 4 shows graphical views illustrating n-best distribution in terms of decoder vocabulary prediction rate and predicted vocabulary size for an exemplary embodiment of the present invention;

FIG. 5 illustrates a sequence of segmented words and corresponding word lattice according to an exemplary embodiment of the present invention; and

FIG. 6 is a flowchart according to an exemplary method for providing dynamic vocabulary prediction for speech recognition according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

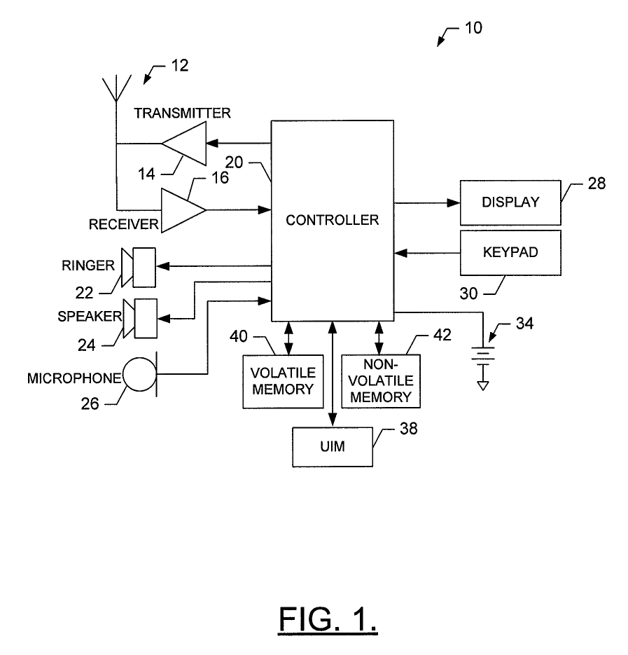

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

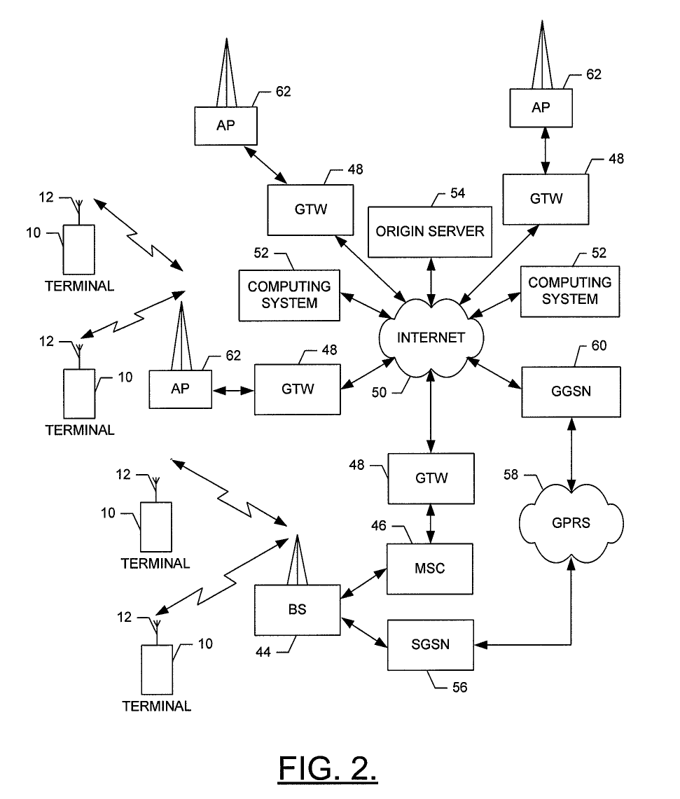

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX, UWB techniques and/or the like.

In an exemplary embodiment, data associated with a speech recognition application or other speech processing application may be communicated over the system of FIG. 2 between a mobile terminal, which may be similar to the mobile terminal 10 of FIG. 1 and a network device of the system of FIG. 2, or between mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, or may be resident on a network device or other device accessible to the communication device.

In a typical speech recognition application such as, for example, isolated word based speech recognition, a speaker may be asked to speak with a clear pause between words in order to enable the word to be segmented by voice activity detection (VAD). It should be noted that while speaking with a clear pause between the words may enhance the accuracy of a speech recognition application, it is also possible to apply the principles disclosed herein to normal speech. However, recognition error rate may be increased in such applications.

VAD may be used to detect word boundaries so that speech recognition may be carried out only on a single segmented word at any given time. The n-best word candidates may then be given for each segmented word. Once the same process has been performed for each word in an utterance, a word lattice may then be produced including each of the n-best word candidates for each corresponding word of the utterance. The word candidates of the word lattice may be listed or otherwise organized in order of a score that represents a likelihood that the word candidate is the correct word. In this regard, one way of scoring the word candidates is to provide an acoustic score and a language score such as a language model (LM) n-gram value. The acoustic score is a value based on sound alone. In other words, the acoustic score represents a probability that the word candidate matches the spoken word being analyzed based only on the sound of the spoken word. Meanwhile, the language score takes into account language attributes such as grammar to determine the probability that a particular word candidate matches the spoken word being analyzed based on language probabilities accessible to the application. For example, if the first word of an utterance is “I”, then the probability of the second word spoken being “is” would be very low, while the probability of the second word spoken being “am” would be much higher. It is traditional to use the term language model (LM) for the statistical n-gram models of word sequences that use the previous n-1 words to predict the next one. The n-gram LM may be trained on a large text corpus. After calculating a value for the acoustic score and the language score, a combined or composite score may be acquired that may subsequently be used to order each of the candidate words.

Based on the recognition of a particular word, it may be possible to use statistical information regarding the likelihood of other words following the particular word in order to create a recognition network including the words that are most likely to follow the particular word (e.g., best candidate followers). The recognition network may then be utilized for comparing models of words in the recognition network to sample speech, such as a subsequent word, following the particular word. By creating the recognition network as a subset of vocabulary words, runtime memory and other resource usage may be reduced since a smaller number of models are compared to the sample speech.

However, for any given word for which word recognition has been conducted as described above, there is a chance that the word was recognized improperly. Accordingly, it may be desirable to create the recognition network, not just based on the best candidate followers for the best word (e.g., the word having the highest composite score), but based on a list of all of the best candidate followers for several best candidate recognized words. In other words, based on the acoustic and language scores generated during a recognition operation, a list of best candidate recognized words may be generated. In one example, a fixed number of best candidate recognized words may be generated based on the combined acoustic and language scores (which may be weighted in some fashion known in the art). For each of the best candidate recognized words, a corresponding list of best candidate followers may form the recognition network.

In an effort to further reduce a size of the recognition network, embodiments of the present invention may incorporate a confidence measure to be used for dynamic selection of selected ones of the best candidate recognized words (e.g., selected candidate words) based on a difference between each of the best candidate recognized words and the best candidate recognized word (e.g., the candidate recognized word having the highest combined acoustic and language score). Only best candidate followers associated with the selected candidate words (i.e., candidate words that have a confidence measure within a threshold distance from the best candidate recognized word) may then be used to form the recognition network thereby providing dynamic vocabulary prediction.

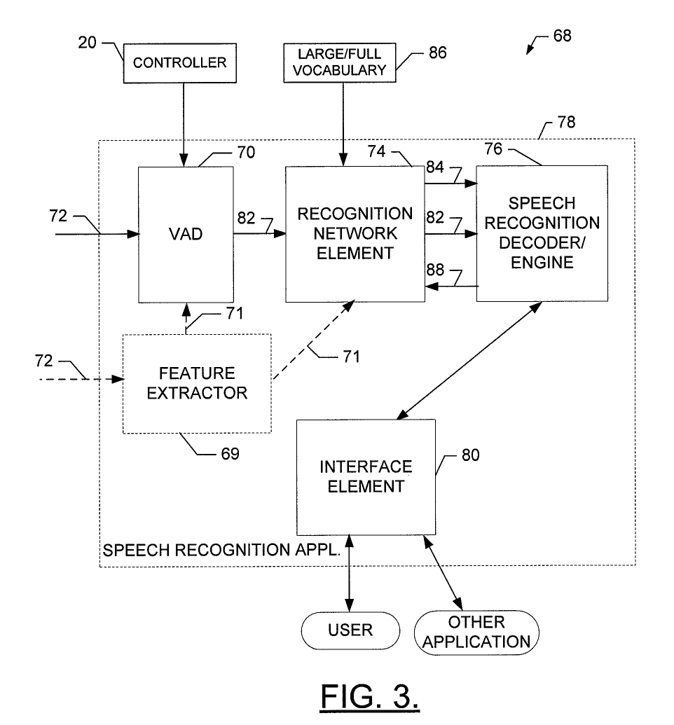

FIG. 3 illustrates a block diagram of a system for providing dynamic vocabulary prediction for speech recognition according to an exemplary embodiment of the present invention. An exemplary embodiment of the invention will now be described with reference to FIG. 3, in which certain elements of a system for providing dynamic vocabulary prediction for speech recognition are displayed. The system of FIG. 3 will be described, for purposes of example, in connection with the mobile terminal 10 of FIG. 1. However, it should be noted that the system of FIG. 3, may also be employed in connection with a variety of other devices, both mobile and fixed, and therefore, embodiments of the present invention should not be limited to application on devices such as the mobile terminal 10 of FIG. 1. It should also be noted, that while FIG. 3 illustrates one example of a configuration of a system for providing dynamic vocabulary prediction for speech recognition, numerous other configurations may also be used to implement embodiments of the present invention. In this regard, although segmentation of words is illustrated in FIG. 3 as being performed by a VAD element 70, any other known mechanism for sentence segmentation may alternatively be employed.

Referring now to FIG. 3, a system 68 for providing dynamic vocabulary prediction for speech recognition is provided. The system 68 includes a speech processing element for segmenting input speech 72 into speech samples such as individual words, a recognition network element 74 and a speech recognition decoder/engine 76. As stated above, the speech processing element of one exemplary embodiment may be the VAD element 70. The VAD element 70 may be in communication with the speech recognition decoder/engine 76 via the recognition network element 74, as shown in FIG. 3, or alternatively, the VAD element 70 and the speech recognition decoder/engine 76 could be communicatively coupled independent of the recognition network element 74. In either case, the recognition network element 74 may provide an input to the speech recognition decoder/engine 76 for providing information regarding a recognition network.

In an exemplary embodiment, the VAD element 70, the recognition network element 74 and the speech recognition decoder/engine 76 may each be embodied by and/or operate under the control of a processing element. In this regard, some or each of the VAD element 70, the recognition network element 74 and the speech recognition decoder/engine 76 may be embodied by and/or operate under the control of a single processing element. Alternatively, a single or even multiple processing elements may perform all of the functions associated with one or more of the VAD element 70, the recognition network element 74 and the speech recognition decoder/engine 76. Processing elements as described herein may be embodied in many ways. For example, a processing element may be embodied as a processor, a coprocessor, a controller or various other processing means or devices including integrated circuits such as, for example, an ASIC (application specific integrated circuit).

As shown in FIG. 3, the VAD 70, the recognition network element 74 and the speech recognition decoder/engine 76 according to one embodiment may be portions of a speech recognition application 78 that operates under the control of a processing element such as the controller 20 of the mobile terminal 10. The speech recognition application 78 may also include an interface element 80, which may be any means or device capable of communicating the output of the speech recognition decoder/engine 76 to, for example, a display to allow user interface with regard to the output of the speech recognition decoder/engine 76. Alternatively, the interface element 80 may provide the output of the speech recognition decoder/engine 76 to another application for further processing. In an exemplary embodiment, the VAD 70, the recognition network element 74, the speech recognition decoder/engine 76 and/or the interface element 80 may be embodied in the form of software applications executable by the controller 20. As such, instructions for performing the functions of the VAD 70, the recognition network element 74, the speech recognition decoder/engine 76 and/or the interface element 80 may be stored in a memory (for example, either the volatile memory 40 or the non-volatile memory 42) of the mobile terminal 10 and executed by the controller 20.

The VAD 70 may be any device or means embodied in either hardware, software, or a combination of hardware and software that is capable of monitoring signals including voice data (e.g., the input speech) and determining whether voice activity is present. For example, in response to receipt of a call, such as a wireless telephone call, the receiver 16 may communicate call data to the VAD 70. The call data may be any type of call including an IP call (for example, VoIP, Internet call, Skype, etc.) or a conference call. The call data may include caller voice data which can be detected by the VAD 70. Additionally, user voice data input into the mobile terminal 10 by, for example, the microphone 26 may be communicated to the VAD 70 and detected. In response to detection of voice data, the VAD 70 may be capable of signaling periods of silence and periods of voice activity in the voice data. Accordingly, the VAD 70 may be used to detect and/or indicate word boundaries. For example, if the speech recognition application 78 is an isolated word speech dictation application, the user may be prompted to speak each word with a clear pause between words so that the VAD 70 may detect word boundaries and communicate segmented voice data 82 to the recognition network element 74 and/or to the speech recognition decoder/engine 76.

In an alternative exemplary embodiment, illustrated in dotted lines in FIG. 3, the system may include a feature extractor 69 configured to extract feature vectors 71 from the input speech 72 and outputting the feature vectors 71 to the VAD 70 and the recognition network element 74. In such an embodiment, the recognition network element 74 may receive the feature vectors 71 from the feature extractor and may receive information as to which feature vectors correspond to speech and which correspond to silence from the VAD 70.

The speech recognition decoder/engine 76 may be any speech recognition decoder/engine known in the art. In an exemplary embodiment, the speech recognition decoder/engine 76 may be any device or means embodied in either hardware, software, or a combination of hardware and software that is capable of examining speech samples from the received segmented voice data 82 and generating acoustic and language scores, as described above, for candidate words corresponding to each word of the segmented voice data 82. In an exemplary embodiment, the speech recognition decoder/engine 76 may be configured to receive recognition network information 84 from the recognition network element 74 so that acoustic and language scores may only be generated for a limited subset of candidate words. In this regard, the recognition network information 84 may include a listing of words of the recognition network and only words of the recognition network may be used for score calculation. Alternatively, the recognition network information 84 may include acoustic modeling information for each word of the recognition network. The mechanism used to determine the recognition network will be described in greater detail below.

In an exemplary embodiment, the speech recognition decoder/engine 76 may be in communication with a memory element (e.g., either the volatile memory 40 or the non-volatile memory 42) which may store a large or full vocabulary 86. The large or full vocabulary 86 may include a listing of words and their corresponding phonetic pronunciations. In one embodiment, the speech recognition decoder/engine 76 may access the large or full vocabulary 86 in order to access acoustic modeling information for words of the recognition network to use for composite score and/or other score calculations. However, as an alternative embodiment, the speech recognition decoder/engine 76 may receive the acoustic modeling information for words of the recognition network to use in composite score and/or other score calculations directly from the recognition network element 74. The speech recognition decoder/engine 76 may then perform composite score and/or other score calculations to generate, for example, a list of best word candidates based on the composite scores. Thus, according to embodiments of the present invention, processing and runtime memory resources may be preserved since the recognition network represents a dynamically selected portion of the full set of vocabulary words based upon which recognition operations may be conducted at the speech recognition decoder/engine 76 thereby reducing the number of candidate words upon which recognition operations must be performed.

The recognition network element 74 may be any device or means embodied in either hardware, software, or a combination of hardware and software that is capable of determining the recognition network information 84 as described in greater detail below. In an exemplary embodiment, the recognition network element 74 may receive word recognition information 88, which may include the list of best word candidates, from the speech recognition decoder/engine 76. As such, the word recognition information 88 may represent a listing of the most likely candidate words (e.g., n-best candidate words) corresponding to a particular word of the input speech 72 in response to recognition operations (e.g., similar to those described above) being performed on the particular word. Using the word recognition information 88, the recognition network element 74 may be configured to dynamically determine the recognition network for each word. In other words, the recognition network element 74 may be configured to dynamically select a subset of words based on the word recognition information 88 for a current word in order to determine the recognition network for the next word to be recognized. Expressed from an alternative perspective, the recognition network element 74 may dynamically determine a recognition network to be used for recognition of a current word based on word recognition information 88 associated with a word upon which recognition operations were previously performed.

In an exemplary embodiment, upon receipt of the word recognition information 88 associated with a word upon which recognition operations were previously performed (e.g., receiving a list of the n-best candidate words based on cumulative scores), the recognition network element 74 may be configured to calculate a confidence measure for each of the n-best candidate words. The best candidate word identified in the word recognition information 88 (e.g., the word among the n-best candidate words having the highest composite score) may be used as a reference value. A distance (in terms of a difference) from the reference value of the best candidate word may be measured or otherwise determined for each other n-best candidate word. Based on the difference between the best candidate word and the remaining n-best candidate words, the recognition network element 74 may be configured to dynamically determine a number of selected candidate words for use in follower word prediction (e.g., prediction of a word likely to follow a current word (or sequence of words) based on language model and/or word frequency information). In an exemplary embodiment, a threshold may be determined and the difference between the best candidate word and the remaining n-best candidate words may be compared to the threshold. Only those n-best candidate words that fall within the threshold (e.g., have a confidence measure close to that of the best candidate word within the threshold amount) may be selected as the selected candidate words. Accordingly, predictions regarding words that are likely to follow a current word being recognized may be based only upon those words that are statistically most likely to be a correct recognition or decode of the current word.

The recognition network element 74 may be further configured to utilize language model information to predict likely follower words for each of the selected candidate words. The result of the prediction of likely follower words may produce a list of best candidate followers including the best candidate follower words for each of the selected candidate words thereby defining the recognition network for the next word to be recognized. Acoustic modeling information for the words of the recognition network for the next word to be recognized may then be utilized for word recognition operations of the next word to be recognized for determining best candidate words for the next word to be recognized as well. The process described above may then be repeated for each subsequent word to be recognized in order to generate a word lattice as described in greater detail below. The process described above is considered “dynamic” since the selected candidate words are selected for each word based only on those words that are statistically likely to be relevant, rather than being based on a fixed number of candidate words which may be invariable or constant for each word.

Generation of a dynamic decoder vocabulary for the recognition network may improve isolated word dictation. For example, if a word to be recognized is not in the decoder vocabulary, then it may be impossible to have correct recognition thereby providing motivation to increase a size of the decoder vocabulary set to reduce the likelihood of such a failure. Meanwhile, if a larger sized decoder vocabulary set is utilized, a larger memory footprint may be required and more computational resources may be utilized. Thus, generating a recognition network by dynamically generating a candidate list of words that are statistically likely to follow the words statistically most likely to be a correct recognition candidate for an immediately preceding word for which recognition operations have been performed, may reduce both the memory footprint and resource consumption utilized in performing recognition operations.

An exemplary embodiment will now be described in the context of a recognition application utilizing a token passing scheme in connection with a Viterbi decoder that is well known in the art, as modified by embodiments of the present invention. In theory, given a word sequence W (i.e. a sentence) and an observation sequence X, a posterior acoustic probability P(W|X) (which is impossible to know in advance) may be calculated by applying Bayes rule as shown below:

$$P \text{(} W \vert X ) = \frac{P ( X \vert W ) \cdot P ( W )}{P ( X )} , \qquad ( 1 )$$

where P(X) is usually not considered because it is difficult to estimate reliably. In practice, a log function may be applied to produce

log(P(X|W)+λ·log(P(W) (2)

as a recognition hypothesis measure. With regard to equation (2) above, the first term (i.e., log(P(X|W)) may represent an acoustic score, the second term (i.e., log(P(W)) may represent a language score and the term A may represent a language model scaling factor. The token passing scheme may be used for simplifying the calculation.

The n-best recognition candidates (i.e., n-best candidate words) may be given as the output from the decoder ranked based on token based accumulative acoustic scores. Token passing can be used for computing the overall most likely sentence hypothesis (accumulative scores) given the acoustic scored word lists in each word segment and language model probability. By taking acoustic and LM n-gram scores into account in the token passing, an accumulative score may be determined by:

$${accumulative\_score}_{i} = {accumulative\_score}_{i - 1} + LM\_bigram + \frac{{acoustic\_score}_{i}}{acoustic\_scaling} ,$$

which accumulative_scoreᵢ represents the accumulative score for the sentence up to and including wordᵢ and accumulative_scoreᵢ₋ₗ represents the accumulative score for the sentence prior to wordᵢ. LM_bigram may represent a language score for wordᵢ, acoustic _scoreᵢ may represent an acoustic score for wordᵢ and acoustic_scaling may represent a scaling of the acoustic score. A token passing search may be used to find the n-best best recognition candidates based on token passed accumulative scores on n-best recognition candidates and history information (e.g., previous words used in obtaining the cumulative score for a sentence) stored in the tokens. The accumulative scores may be computed from all acoustic scores and scaled language model bigrams along a particular pass. Given ranked n-best recognized word candidates, the language model may again be used to predict a vocabulary set for the next word segment. Both word pairs and backoff unigrams (e.g., common words for the language such as the, and, etc.) may be used for predicting the likely follower words, given the n-best candidate words. Taking a union of all of the follower words as a new vocabulary (i.e., the recognition network), the system may able to repeatedly recognize the next segment in the sentence given a smaller subset of vocabulary for use in the recognition.

As stated above, the confidence measure may be calculated for each of the n-best candidate words. The confidence measure may be calculated according to the following equation in which W is the reference word sequence:

$$\begin{matrix}LLR \text{(} W \vert X ) = log \{ \frac{P ( W \vert X )}{P ( \hat{W} \vert X )} \} \\ = log \{ \frac{P ( X \vert W ) \cdot P ( W )}{P ( X \vert \hat{W} ) \cdot P ( \hat{W} )} \} \\ = log \{ P ( X \vert W ) \cdot P ( W ) \} - log \{ P ( X \vert \hat{W} ) \cdot P ( \hat{W} ) \} .\end{matrix} \qquad ( 3 )$$

In equation (3), LLR represents a logarithm of a likelihood ratio. As such, the LLR represents a normalization of a reference score. The reference word sequence can be approached in several ways, e.g. anti-model. In an exemplary embodiment, the reference word sequence may be modeled by obtaining scores for n-best word sequences. The best scored word sequence (e.g., the word sequence with the highest cumulative score) may be chosen as the reference word sequence.

Based on equation (3) above, it may be possible to calculate the confidence measure using equation (4) below. According to equation (4), the confidence measure for each word sequence is determined based on a difference between the accumulative score of the word sequence (e.g., the accumulation of each word score for the given word sequence, up to the current word) and the best accumulative score (e.g., the accumulative score of the best word sequence). In an exemplary embodiment, the confidence measure is normalized for word duration by dividing the difference between the accumulative score of the word sequence and the best accumulative score by the word duration. The confidence measure may therefore be calculated by:

$$confidence = \frac{\begin{matrix}( accumulative\_score - \\ best\_accumulative \_score )\end{matrix}}{word\_duration} . \qquad ( 4 )$$

The confidence measure for the best scored word sequence may be established as a reference (which using equation (4) would be zero). The confidence measure of each other word sequence may be compared to the confidence measure of the best scored word sequence to determine, based on a difference between the confidence measures, which of the word sequences are within a threshold amount of difference from the confidence measure of the best scored word sequence. Current words for each of the word sequences that are within the threshold amount of difference may be considered as selected candidate words. Thereafter, given the selected candidate words, the recognition network element 74 may determine the recognition network based on the selected candidate words by predicting likely follower words in order to produce the best candidate follower words for each of the selected candidate words. In an exemplary embodiment, instead of utilizing a normalized accumulative score as described above, it may be possible to utilize a normalized acoustic score for confidence measure calculations.

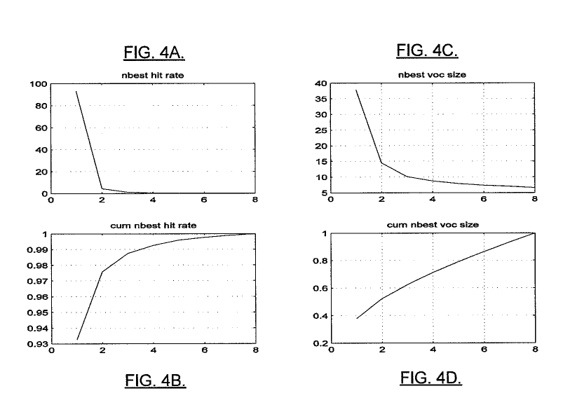

FIG. 4 shows graphical views illustrating n-best distribution in terms of decoder vocabulary prediction rate and predicted vocabulary size for an exemplary embodiment in which the confidence measure of the best word sequence is 0 and the threshold is set at −0.03. In FIG. 4A, the vertical axis represents a percentage of how often a correct next word is within a list of a length indicated on the horizontal axis. Thus, according to this exemplary embodiment, the correct word may be in a 1-best list of words about 93% of the time. Meanwhile, if a 2-best words list is used, the correct word may be in the 2-best list about an additional 5% of the time. FIG. 4B shows the same data depicted in FIG. 4A in a cumulative manner. As shown in FIG. 4B, the correct word may be in the 2-best list about 98% of the time (i.e., the sum of 93% and 5% from FIG. 4A). FIG. 4C shows a percentage of an 8-best vocabulary size given n being 1 through 8 number of selected candidate words. FIG. 4D shows the same data as is illustrated in FIG. 4C in a cumulative manner. Accordingly, if one selected candidate word is utilized, the vocabulary size of the recognition network may be about 37% of a vocabulary set generated using eight selected candidate words. Meanwhile, if two selected candidate words are utilized, the vocabulary size increases by about 13% to a cumulative vocabulary size of about 50% of the vocabulary set generated using eight selected candidate words. Thus, for example, according to an exemplary embodiment, if the number of selected candidate words is two, there is approximately a 98% chance that the correct word will be in the predicted list and the recognition network will be about 50% smaller than it would be for an eight selected candidate word scenario. Thus, using 2-best word according to embodiments of the present invention may provide a relatively good performance and adding more candidates in an n-best list may only marginally improve performance with an increase in memory usage.

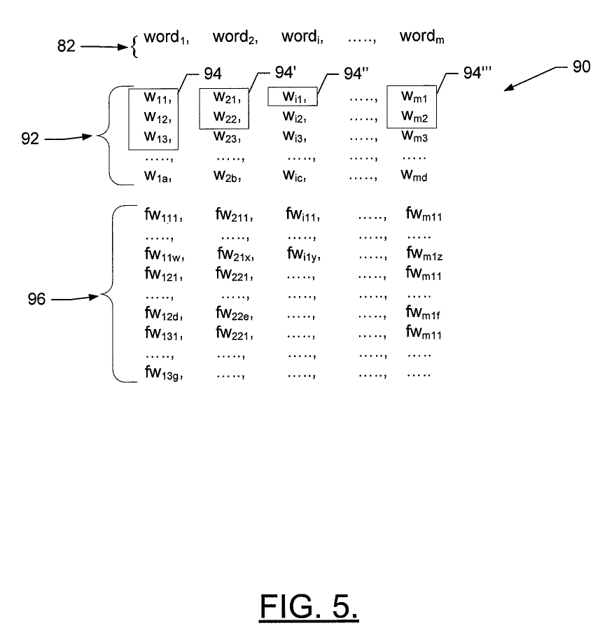

An exemplary embodiment will now be described in greater detail with reference to FIG. 5, in which a sequence of spoken words such as a particular sentence or phrase is received as the input speech 72, and output by the VAD 70 as the segmented voice data 82 shown in FIG. 4. In this regard, the segmented voice data 82 includes each of the words (word₁ to wordₘ) of the sentence or phrase. The speech recognition decoder/engine 76 is configured to construct a word lattice 90 from the segmented voice data 82. The word lattice 90 includes candidate words 92 corresponding to each of the words of the sentence or phrase. For example, candidate words w₁₁ to w₁ₙ correspond to word₁, candidate words wᵢₗ to wᵢₙ correspond to words and candidate words wₘₗ to wₘₙ correspond to wordₘ. The candidate words 92 of the word lattice 90 may be listed or otherwise organized such that candidates having a highest composite score are listed or otherwise presented first while remaining candidate words are listed or otherwise presented in order of descending composite scores. In other words, the candidate words 92 may be presented in a list of best word candidates. In an exemplary embodiment, the list of best word candidates may be a listing of words from a corresponding recognition network for the respective word being recognized, in which the listing of words are ranked based on cumulative scores. As described above, the list of best candidate words may be provided to the recognition network element 74 as a portion of the word recognition information 88.

During operation, given the candidate words 92, the recognition network element 74 may calculate a confidence measure for each of the candidate words 92. The best candidate word may be assigned a confidence measure of a reference value (e.g., 0) and a confidence measure relative to the reference value may be calculated for each other candidate word as described above. The confidence measure for each of the other candidate words may be compared to a threshold and those candidate words having a confidence measure within the threshold may be selected as selected candidate words 94. The selected candidate words 94 may then be utilized for predicting likely follower words 96 to determine the recognition network for each word to be recognized as described above. In this regard, as can be seen from FIG. 5, likely follower words 96 are predicted corresponding to each of the selected candidate words 94 for each given word of the sequence. Thus, for example, if it is assumed that word candidate w₁₁ is the best word candidate, the corresponding confidence measure for word candidate w₁₁ may be zero. If the threshold is set to −0.3 and it is assumed that word candidate w₁₂ has a confidence measure of −0.1, word candidate w₁₃ has a confidence measure of −0.25 and all remaining word candidates have confidence measures less than −0.3, then word candidate w₁₂ and word candidate w₁₁ may each meet the threshold criteria with respect to the best word candidate and may thus be selected candidate words along with word candidate w₁₁. Accordingly, likely follower words for each of the selected candidate words may be determined using, for example, language models. Thus, for example, follower words fw₁₁₁ to fw_{11w} may correspond to word candidate w₁₁, follower words fw₁₂₁ to fw_{12d} may correspond to word candidate w₁₂, and follower words fw₁₃₁ to fw_{13g} may correspond to word candidate w₁₃. Selected candidate words are also shown for each other word of the sequence (e.g., 94′, 94″, and 94′″).

As stated above, the composite score may include an acoustic score and a language score, which may be known as an LM n-gram. The acoustic score represents a probability that the word candidate (for example w₁₁) matches the corresponding spoken word (for example word₁) based only on the sound of the corresponding spoken word. In this regard, the acoustic score may be stored in association with each word or node. Meanwhile, the language score takes into account language attributes such as grammar to determine the probability that a particular word candidate (for example w₁₁) matches the spoken word (for example word₁) being analyzed based on language probabilities accessible to the application that are associated with each consecutive word pair (for example word₁ and word₂). In this regard, the language score is defined for each consecutive word pair, which may also be called an arc or transition. The language score may be calculated based on language probabilities that may be stored in a memory of the mobile terminal 10, or otherwise accessible to a device practicing embodiments of the invention. The composite score may also include scaling in order to balance between the acoustic and language scores.

Thereafter, a sentence level search may be performed. In this regard, after candidate recognized words have been obtained for all word segments (e.g., w₁₁, . . . , w₁ₐ, w₂₁, . . . , w_{2b}, . . . ), for example, a sentence level search may be performed for the candidate recognized words based on the language model scores and obtained acoustic model scores. The sentence level search provides the most likely sequence of words in the word lattice, which may be an output of the speech recognition decoder/engine 76.

In an exemplary embodiment, the word lattice 90 may be constructed one word at a time. For example, the candidate words corresponding to word₁ may be assembled prior to the assembly of the candidate words corresponding to word₂. The speech recognition decoder/engine 76 may be configured to produce any number of candidate words corresponding to each of the words of the sentence or phrase. For example, the speech recognition decoder/engine 76 may be configured to calculate only a top ten or any other selected number of candidate words for each corresponding word or the sentence or phrase. As stated above, the candidate words 92 may be presented, listed, organized, etc. in order of composite score. As such, the candidate words 92 may be ranked in order of the likelihood that each candidate word matches the actual corresponding spoken word based on a balance between both acoustic and language scores. Candidate sentences may then be constructed based on the candidate words 92 by constructing sentences including the candidate words 92. The speech recognition decoder/engine 76 may be configured to determine any number of candidate sentences. For example, the adaptive speech recognition decoder/engine 76 may be configured to determine ten candidate sentences, or n-best sentences ranked according to a summation of the composite scores of the candidate words. The candidate sentences may be organized, listed, presented or otherwise ranked in order of likelihood that the candidate sentence correctly matches the spoken sentence or phrase based on a balance between acoustic and language scores of each of the candidate words of the candidate sentence. In this regard, the candidate sentences may have a corresponding composite score or sentence score. The candidate sentences may then be communicated to the interface element 80 for output to a user or to another application.

The interface element 80 may present the candidate sentences to the user for confirmation, modification or selection via, for example, a display. The presentation of the candidate sentences may be accomplished in a list format, such as by listing a specific number of candidate sentences on a display and enabling the user to select a best or correct one of the candidate sentences. The best or correct one of the candidate sentences should be understood to include the candidate sentence that matches or most closely matches the actual spoken sentence or phrase. In such an embodiment, the user may be presented with a complete list of all candidate sentences or a selected number of candidate sentences in which remaining candidate sentences may be viewed at the option of the user if none of the currently displayed candidate sentences include the best or correct one of the candidate sentences. Alternatively, the user may be presented with a single candidate sentence at any given time, which represents the candidate sentence with the highest composite score that has not yet been viewed by the user. In such an embodiment, the user may again be given the option to view the next most likely candidate sentence if the currently displayed candidate sentence is not the best or correct one of the candidate sentences. In an exemplary embodiment, the user may use the interface element 80 to control attributes of the speech recognition decoder/engine 76 such as, for example, the number of candidate sentences to generate, the number of candidate sentences to display, the order in which to display candidate sentences, etc.

It should be noted that in some cases, prediction of the recognition network for a next word to be recognized may depend at least in part upon whether a match or a mismatch occurs between training and testing sets of a particular language model. In a matching case, the discussion provided above may be employed. However, in a mismatching case, it may be desirable to include, for example, a predefined set of supplemental words as part of the recognition network. In an exemplary embodiment, the predefined set may include a set of frequently used words and/or acoustic matching candidates appended to the likely follower words to form the recognition network.

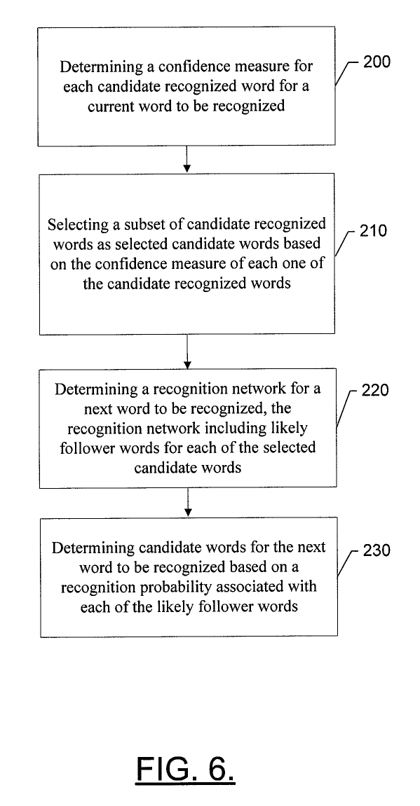

FIG. 6 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal and executed by a built-in processor in a mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method of providing dynamic vocabulary prediction for speech recognition may include determining a confidence measure for each candidate recognized word for a current word to be recognized at operation 200. A subset of candidate recognized words may be selected as selected candidate words based on the confidence measure of each one of the candidate recognized words at operation 210. At operation 220, a recognition network may be determined for a next word to be recognized. The recognition network may include likely follower words for each of the selected candidate words. The method may also include determining candidate words for the next word to be recognized based on a recognition probability associated with each of the likely follower words at an optional operation 230.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
determining a confidence measure for each candidate recognized word for a current word to be recognized;
selecting a subset of candidate recognized words as selected candidate words based on the confidence measure of each one of the candidate recognized words; and
determining a recognition network for a next word to be recognized, the recognition network including likely follower words for each of the selected candidate words.

2. A method according to claim 1, wherein determining the confidence measure comprises determining a relative difference between one of the candidate recognized words and a best candidate recognized word.

3. A method according to claim 2, wherein determining the relative difference comprises determining a difference between an accumulative score of a particular candidate recognized word and an accumulative score of the best candidate recognized word having a highest accumulative score.

4. A method according to claim 3, wherein determining the confidence measure further comprises normalizing the confidence measure by dividing the relative difference by a word duration of the word to be recognized.

5. A method according to claim 1, wherein selecting the subset comprises comparing the confidence measure to a threshold and defining the selected candidate words as the candidate recognized words having corresponding confidence measures that meet the threshold.

6. A method according to claim 1, wherein determining the recognition network comprises determining likely follower words for each of the selected candidate words based on language model information.

7. A method according to claim 1, further comprising determining candidate words for the next word to be recognized based on a recognition probability associated with each of the likely follower words.

8. A method according to claim 1, further comprising including a predefined set of supplemental words as part of the recognition network.

9. A method according to claim 8, wherein including the predefined set of supplemental words comprises including at least one of frequently used words or acoustic matching candidates.

10. A computer program product comprising at least one computer-readable storage medium having computer-readable program code portions stored therein, the computer-readable program code portions comprising:
a first executable portion for determining a confidence measure for each candidate recognized word for a current word to be recognized;
a second executable portion for selecting a subset of candidate recognized words as selected candidate words based on the confidence measure of each one of the candidate recognized words; and
a third executable portion for determining a recognition network for a next word to be recognized, the recognition network including likely follower words for each of the selected candidate words.

11. A computer program product according to claim 10, wherein the first executable portion includes instructions for determining a relative difference between one of the candidate recognized words and a best candidate recognized word.

12. A computer program product according to claim 11, wherein the first executable portion includes instructions for determining a difference between an accumulative score of a particular candidate recognized word and an accumulative score of the best recognized candidate word having a highest accumulative score.

13. A computer program product according to claim 12, wherein the first executable portion includes instructions for normalizing the confidence measure by dividing the relative difference by a word duration of the word to be recognized.

14. A computer program product according to claim 10, wherein the second executable portion includes instructions for comparing the confidence measure to a threshold and defining the selected candidate words as the candidate recognized words having corresponding confidence measures that meet the threshold.

15. A computer program product according to claim 10, wherein the third executable portion includes instructions for determining likely follower words for each of the selected candidate words based on language model information.

16. A computer program product according to claim 10, further comprising a fourth executable portion for determining candidate words for the next word to be recognized based on a recognition probability associated with each of the likely follower words.

17. A computer program product according to claim 10, further comprising a fourth executable portion for including a predefined set of supplemental words as part of the recognition network.

18. A computer program product according to claim 17, wherein the fourth executable portion includes instructions for including at least one of frequently used words or acoustic matching candidates.

19. An apparatus comprising a recognition network element configured to:
determine a confidence measure for each candidate recognized word for a current word to be recognized;
select a subset of candidate recognized words as selected candidate words based on the confidence measure of each one of the candidate recognized words; and
determine a recognition network for a next word to be recognized, the recognition network including likely follower words for each of the selected candidate words.

20. An apparatus according to claim 19, wherein the recognition network element is further configured to determine a relative difference between one of the candidate recognized words and a best candidate recognized word.

21. An apparatus according to claim 20, wherein the recognition network element is further configured to determine a difference between an accumulative score of a particular candidate recognized word and an accumulative score of the best candidate recognized word having a highest accumulative score.

22. An apparatus according to claim 21, wherein the recognition network element is further configured to normalize the confidence measure by dividing the relative difference by a word duration of the word to be recognized.

23. An apparatus according to claim 19, wherein the recognition network element is further configured to compare the confidence measure to a threshold and define the selected candidate words as the candidate recognized words having corresponding confidence measures that meet the threshold.

24. An apparatus according to claim 19, wherein the recognition network element is further configured to determine likely follower words for each of the selected candidate words based on language model information.

25. An apparatus according to claim 19, further comprising a speech recognition engine configured to determine candidate words for the next word to be recognized based on a recognition probability associated with each of the likely follower words.

26. An apparatus according to claim 19, wherein the recognition network element is further configured to include a predefined set of supplemental words as part of the recognition network.

27. An apparatus according to claim 26, wherein the predefined set of supplemental words comprises at least one of frequently used words or acoustic matching candidates.

28. An apparatus according to claim 19, wherein the apparatus is embodied as a mobile terminal.

29. An apparatus comprising:
means for determining a confidence measure for each candidate recognized word for a current word to be recognized;
means for selecting a subset of candidate recognized words as selected candidate words based on the confidence measure of each one of the candidate recognized words; and
means for determining a recognition network for a next word to be recognized, the recognition network including likely follower words for each of the selected candidate words.

30. An apparatus according to claim 29, wherein means for determining the confidence measure comprises means for determining a relative difference between one of the candidate recognized words and a best candidate recognized word.

31. A system comprising:
a speech processing element configured to segment input speech into a series of words including a current word to be recognized and a next word to be recognized;
a speech recognition engine configured to determine candidate recognized words corresponding to each word of the series of words based on a recognition network dynamically generated for each word of the series of words; and
a recognition network element configured to:
determine a confidence measure for each candidate recognized word for the current word to be recognized;
select a subset of candidate recognized words for the current word to be recognized as selected candidate words based on the confidence measure of each one of the candidate recognized words for the current word to be recognized; and
determine a next recognition network for a next word to be recognized, the next recognition network including likely follower words for each of the selected candidate words.

32. A system according to claim 31, wherein the recognition network element is further configured to determine a relative difference between one of the candidate recognized words and a best candidate recognized word.
